(19) United States
(12) Patent Application Publication
(10) Pub. No.: US 2013/0181659 A1
(43) Pub. Date: Jul. 18, 2013

(54) CHARGING DEVICE AND CHARGING METHOD

(71) Applicants: Yung-Hsi CHANG, Hsinchu County (TW); Yi-Feng LUO, Yilan County (TW); Chueh-Hao YU, Yunlin County (TW); Kai-Cheung JUANG, Hsinchu City (TW)

(72) Inventors: Yung-Hsi CHANG, Hsinchu County (TW); Yi-Feng LUO, Yilan County (TW); Chueh-Hao YU, Yunlin County (TW); Kai-Cheung JUANG, Hsinchu City (TW)

(21) Appl. No.: 13/601,430

(22) Filed: Aug. 31, 2012

(30) Foreign Application Priority Data
Jan. 18, 2012 (TW) 101101879

(51) Int. Cl. H02J 7/00

(52) U.S. Cl. 320/107; 320/162

(57) ABSTRACT

An exemplary embodiment provides a charging method. The charging method includes detecting a charging current and producing a current-detecting signal according to the charging current; comparing the current-detecting signal with a first reference voltage and producing a current comparison signal accordingly; producing a second reference voltage according to the current comparison signal; comparing a battery voltage of a battery with the second reference voltage and producing a voltage comparison signal accordingly; producing a set of control signals according to the voltage comparison signal; and producing an adjusted charging voltage according to the control signals and a charging voltage, wherein the charging current is produced by the adjusted charging voltage to charge the battery.

### CROSS REFERENCE TO RELATED APPLICATIONS

This Application claims priority of Taiwan Patent Application No. 101101879, filed on Jan. 18, 2012, the entirety of which is incorporated by reference herein.

### TECHNICAL FIELD

The exemplary embodiments relate to a charging device.

### BACKGROUND

Recently, the growth of the application for portable electronic devices, such as cell phones, personal digital assistants, and music players, has led to an increase in the popularity of rechargeable batteries. Normally, rechargeable batteries can generate stable voltage and current to make the portable electronic devices work properly. However, voltage generated by rechargeable batteries will decrease with the power of rechargeable batteries. Portable electronic devices or circuits can not be operated normally when the voltage of the battery is lower than a level. Thus, rechargeable batteries provide the recharging function, such that batteries can be reused. Currently, the market is flooded with a variety of rechargeable batteries. Therefore, providing a rapid and safe charging method to recharge various batteries will become a considerable challenge.

Using an improper way to charge a rechargeable or non-rechargeable battery May not only decrease the performance and the life of battery but also lead to a safety risk. In regard to this, the exemplary embodiments will provide the charging system and method to recharge the battery. The charging system and method simplify the electric circuit with the traditional constant current charging mode, provide a stable and safe charging device, and extend the life of battery.

### BRIEF SUMMARY

A detailed description is given in the following embodiments with reference to the accompanying drawings. An exemplary embodiment provides a charging device. The charging method includes a charging detecting circuit, which detecting a charging current and producing a current-detecting signal according to the charging current; a first comparator, which comparing the current-detecting signal with a first reference voltage and producing a current comparison signal accordingly; a reference voltage generator, which producing a second reference voltage according to the current comparison signal; a second comparator, which comparing a battery voltage of a battery with the second reference voltage and producing a voltage comparison signal accordingly; a logic control circuit, which producing a set of control signals according to the voltage comparison signal; and a power stage circuit, which receiving a charging voltage, and controlling the charging voltage according to the control signals to produce an adjusted charging voltage, wherein the charging current is produced by the adjusted charging voltage to charge the battery.

Another exemplary embodiment further provides a charging method. The charging method includes detecting a charging current and producing a current-detecting signal according to the charging current; comparing the current-detecting signal with a first reference voltage and producing a current comparison signal accordingly; producing a second reference voltage according to the current comparison signal; comparing a battery Voltage of a battery with the second reference voltage and producing a voltage comparison signal accordingly; producing a set of control signals according to the voltage comparison signal; and producing an adjusted charging voltage according to the control signals and a charging voltage, wherein the charging current is produced by the adjusted charging voltage and used to charge the battery.

### BRIEF DESCRIPTION OF THE DRAWINGS

The exemplary embodiments can be more fully understood by reading the subsequent detailed description and examples with references made to the accompanying drawings, wherein:

FIG. 1 is a schematic diagram illustrating a charging device according to an exemplary embodiment;

FIG. 2 is a flowchart of a charging method according to an exemplary embodiment;

FIG. 3 is a signal simulation diagram illustrating signals of the charging device of exemplary embodiments;

FIG. 4 is a signal simulation diagram illustrating signals of the charging device of exemplary embodiments; and

FIG. 5 is a signal simulation diagram illustrating signals of the charging device of exemplary embodiments.

### DETAILED DESCRIPTION

The following description is of the well-contemplated mode of carrying out the exemplary embodiments. This description is made for the purpose of illustrating the general principles of the exemplary embodiments and should not be taken in a limiting sense. The scope of the exemplary embodiments is best determined by reference to the Appended claims.

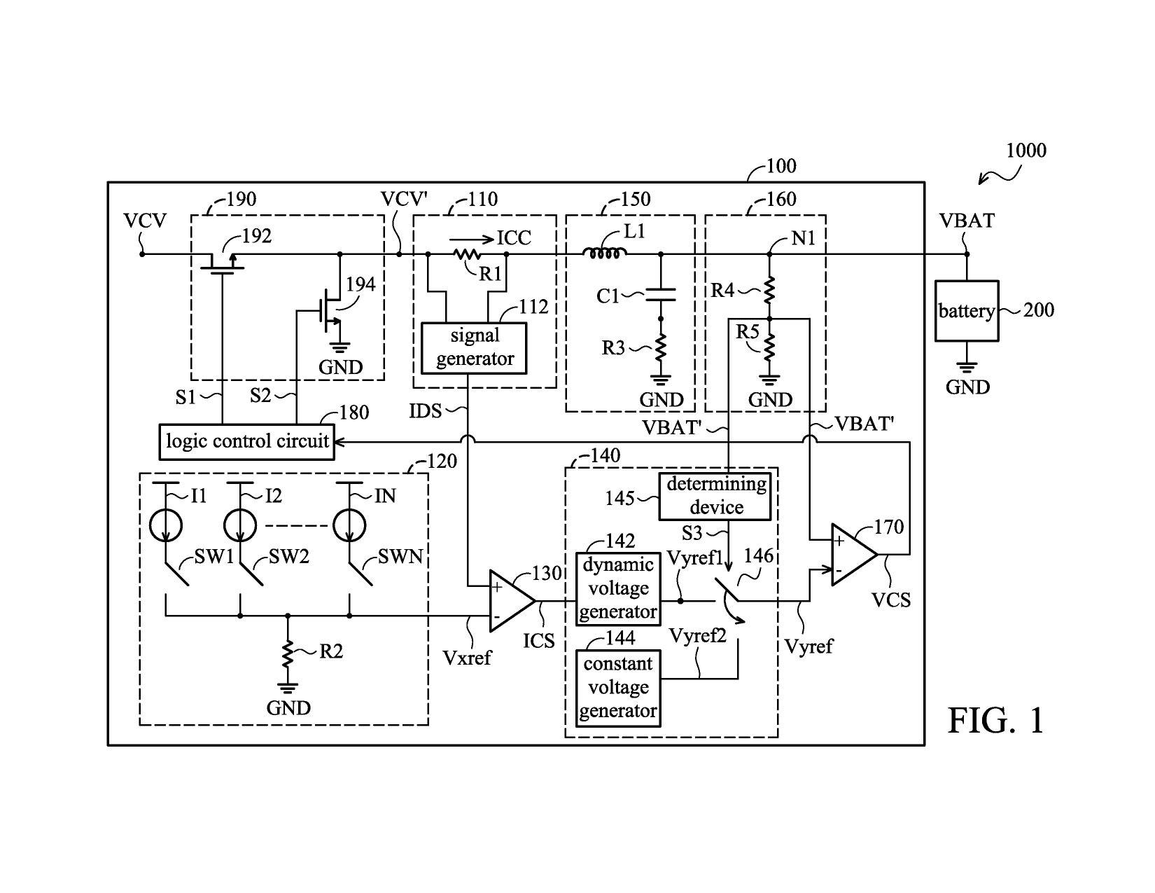

FIG. 1 is a schematic diagram illustrating a charging device according to an exemplary embodiment. The charging system 1000 includes a charging device 100 and a battery 200. The charging device 100 is coupled to a charging voltage VCV and charges the battery 200 according to the charging voltage VCV. The charging device 100 includes a node N1 and charges the battery 200 through the node N1, wherein the node N1 is connected to the battery 200. It should be noted that the charging device 100 has a pre-charge mode Pre_C, a constant voltage mode CV and a constant current mode CC. During the pre-charge mode Pre_C, the charging device 100 provides a lower current (such as 0.2 A) to charge the battery 200. During the constant current mode CC, the charging device 100 provides a charging current ICC (such as 2 A) to charge the battery 200, wherein the charging current ICC is a direct current (DC). During the constant voltage mode CV, the charging device 100 provides a constant voltage (such as 12V) to charge the battery 200, such that the voltage of the battery 200 is raised to the constant voltage (such as 12V). As shown in FIG. 1, the voltage of the battery 200 is the battery voltage VBAT. The battery 200 can be any kind of battery, such as a solar battery, alkaline battery, or lithium battery, etc.

The charging device 100 includes a current detecting circuit 110, a reference current generator 120, a comparator 130, a reference voltage generator 140, a filter circuit 150, a voltage divider circuit 160, a comparator 170, a logic control circuit 180, and a power stage circuit 190. The current detecting circuit 110 detects a charging current ICC, and produces a current-detecting signal IDS according to the charging current ICC. The current detecting circuit 110 includes a resistor R1 and a signal generator 112. The resistor R1 has a first terminal coupled to the power stage circuit 190, and a second terminal coupled to the node N1 through the filter circuit 150. The signal generator 112 produces The current-detecting signal IDS which is corresponding to the charging current ICC according to a voltage drop produced by the resistor R1 and the charging current ICC.

The reference current generator 120 produces a first reference voltage Vxref corresponding to the value of a predetermined charging current according to a predetermined value, wherein the predetermined value represents the charging current ICC which is predetermined according to variety of environments. The reference current generator 120 includes a plurality of constant current sources I1-IN, a plurality of switches SW1-SWN and a resistor R2. Each of the switches SW1-SWN has a first terminal coupled to the constant current sources I1-IN respectively and a second terminal coupled to the resistor R2. The resistor R2 has a first terminal coupled to the second terminals of switches SW1-SWN, and a second terminal coupled to a ground GND. The switches SW1-SWN connect at least one of the constant current sources I1-IN to the resistor R2 according to the predetermined value. The resistor R2 produces the first reference voltage Vxref according to the current from the constant current source(s) connected to the resistor R2.

The comparator 130 compares the current-detecting signal IDS with the first reference voltage Vxref, and produces a current comparison signal ICS accordingly. The reference voltage generator 140 produces a second reference voltage Vyref according to the current comparison signal ICS. The reference voltage generator 140 includes a dynamic voltage generator 142, a constant voltage generator 144, a determining device 145 and a switch 146. The dynamic voltage generator 142 produces a dynamic voltage Vyref1 according to the current comparison signal ICS. For example, the dynamic voltage generator 142 has an initial voltage source, a step-down transformer, and a step-up transformer. The initial voltage provides a dynamic voltage Vyref1 which is predetermined. The step-down transformer and the step-up transformer dynamically adjust the dynamic voltage Vyref1 according to the current comparison signal ICS. For example, when the Output signal of the comparator 130 represents that the current-detecting signal IDS is more than the first reference voltage Vxref, the step-down transformer decreases the current dynamic voltage Vyref1. Namely, when the charging current ICC is more than the predetermined current of the constant current mode CC, the step-down transformer decreases the current dynamic voltage Vyref1. When the output signal of the comparator 130 represents that the current-detecting signal IDS (i.e., a voltage) is less than the first reference voltage Vxref, the step-up transformer increases the current dynamic voltage Vyref1. Namely, when the output signal of the comparator 130 represents that the charging current ICC is less than the predetermined current of the constant current mode CC, the step-up transformer increases the current dynamic voltage Vyref1. The constant voltage generator 144 produces a constant voltage Vyref2.

The determining device 145 is coupled between the resistor R5 and resistor R4 to determine whether the battery voltage VBAT reaches a predetermined voltage according to a divided voltage VBAT′ of the battery voltage VBAT, and sends a determining signal S3 to the switch 146 accordingly. In another embodiment of the exemplary embodiments, the determining device 145 is coupled to the node N1 to determine whether the battery voltage VBAT reaches a predetermined voltage, and sends the determining signal S3 to the switch 146. When the battery voltage VBAT is less than the predetermined voltage (such as 10V) corresponding to the constant voltage mode CV, the switch 146 provides the dynamic voltage Vyref1 to the comparator 170 according to the determining signal S3 to serve as the second reference voltage Vyref. When the battery voltage VBAT reaches (equals or is larger than) the predetermined voltage (such as 10V) corresponding to the constant voltage mode CV, the switch 146 provides the constant voltage Vyref2 to the comparator 170 according to the determining signal S3 to serve as the second reference voltage Vyref. For example, the constant voltage Vyref2 can be the voltage level (such as 12V) of the battery 200 when the battery 200 is fully charged. It should be noted that the predetermined voltage is less than the voltage level of the battery 200 when the battery 200 is fully charged. In another embodiment of the exemplary embodiments, when the battery voltage VBAT is less than a predetermined voltage (such as 12V) corresponding to the constant voltage mode CV, the switch 146 provides the dynamic voltage Vyref1 to the comparator 170 according to the determining signal S3 to serve as the second reference voltage Vyref. When the battery voltage VBAT reaches (equal to or greater than) the predetermined voltage (such as 12V), the switch 146 provides the constant voltage Vyref2 to the comparator 170 according to the determining signal S3 to serve the second reference voltage Vyref. For example, the constant voltage Vyref2 can be the voltage (such as 12V) when the battery 200 is fully charged. It should be noted that the predetermined voltage is equal to the voltage when the battery 200 is fully charged.

The filter circuit 150 filters an adjusted charging voltage VCV′ and a charging current ICC, and sends the filtered adjusted charging voltage VCV′ and the filtered charging current ICC to the voltage divider circuit 160. The filter circuit 150 includes an inductor L1, a capacitor C1 and a resistor R3. The inductor L1 has a first terminal coupled to the current detecting circuit 110, and a second terminal coupled to the node N1. The capacitor C1 has a first terminal coupled to the node N1, and a second terminal coupled to the resistor R3. The resistor R3 has a first terminal coupled to the second terminal of the capacitor C1, and a second terminal coupled to the ground GND. The voltage divider circuit 160 divides the voltage of the battery voltage VBAT, and provides a divided voltage VBAT′ to the comparator 170. The voltage divider circuit 160 includes a resistor R4 and a resistor R5. The resistor R4 includes a first terminal coupled to a node N1, and a second terminal coupled to the resistor R5. The resistor R5 has a first terminal coupled to the second terminal of the resistor R4, and a second terminal coupled to the ground GND. It Should be noted that the values of the inductor L1, the capacitor C1 and the resistor R3 in the filter circuit 150 can be designed according to the different circuits, but the exemplary embodiments are not limited thereto.

The comparator 170 compares a battery voltage VBAT with a second reference voltage Vyref, and produces a voltage comparison signal VCS accordingly. The logic control circuit 180 produces a set of control signals S1 and S2 according to the voltage comparison signal VCS. A power stage circuit 190 receives a charging voltage VCV and controls the charging voltage VCV according to the control signals S1 and S2 to produce the adjusted charging voltage VCV′, and provides the adjusted charging voltage VCV′ to charge the battery 200. The power stage circuit 190 includes a plurality of transistors 192 and 194. The transistor 192 has a first terminal coupled to the charging voltage VCV, a second terminal coupled to the current detecting circuit 110, and a control terminal coupled to the control signal S1 outputted by the logic control circuit 180. The transistor 194 has a first terminal coupled to the current detecting circuit 110, a second terminal coupled to the ground GND, and a control terminal coupled to the control signal S2 outputted by the logic control circuit 180. The transistors 192 and 194 are switched according to the control signals S1 and S2 for producing the adjusted charging voltage VCV′. It should be noted that the power stage circuit 190 of the present embodiment produces a pulse width modulation signal (PWM) by switching the transistors 192 and 194. In other words, the adjusted charging voltage VCV′ is a pulse width modulation signal. It should be noted that the charging current ICC is produced by the adjusted charging voltage VCV′ to charge the battery 200.

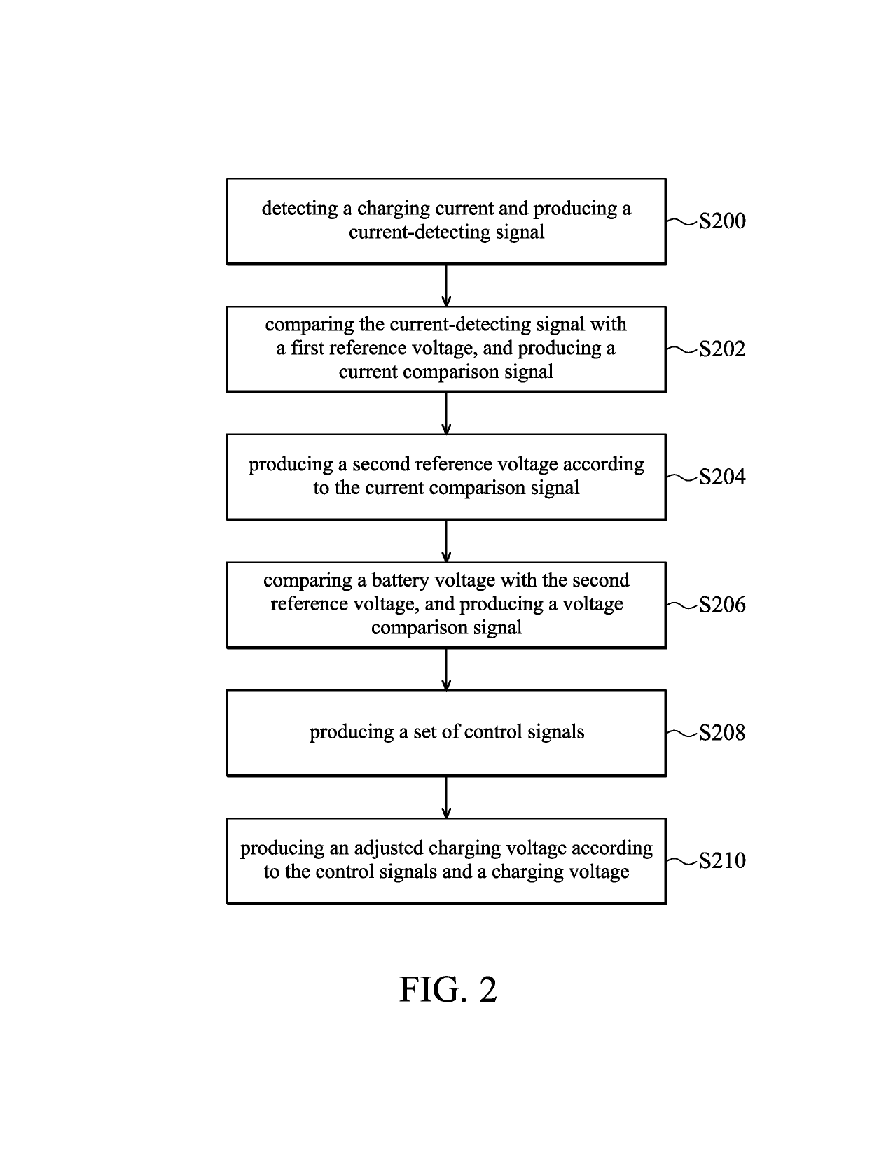

FIG. 2 is a flowchart of a charging method according to an exemplary embodiment. The process starts at step S200.

In step S200, the current detecting circuit 110 detects a charging current ICC and produces a current-detecting signal IDS according to the detected charging current ICC. The current detecting circuit 110 produces the current-detecting signal IDS corresponding to the charging current ICC according to a voltage drop produced by the charging current ICC passing through the resistor R1. It should be noted that the charging current ICC (such As 2 A) is produced by the charging voltage VCV to charge the battery 200 when the charging device 100 is under the constant current mode CC, wherein the charging current ICC is a direct current.

In step S202, the comparator 130 compares the current-detecting signal IDS with a first reference voltage Vxref, and produces a current comparison signal ICS. For example, the switches SW1-SW2 of the reference current generator 120 conduct at least one of a plurality of constant current sources I1-IN with the resistor R2 according to a predetermined value, and produces a first reference voltage Vxref by at least one conducted constant current source(s) I1-IN. The predetermined value represents the charging current ICC of the constant current mode CC, wherein the charging current ICC is predetermined according variety of environments.

After this, in step S204, the reference voltage generator 140 produces a second reference voltage Vyref according to the current comparison signal ICS. In some embodiments, the reference voltage generator 140 produces a dynamic voltage Vyref1 to serve as the second reference voltage Vyref according to the current comparison signal ICS when the battery voltage VBAT is less than a predetermined voltage. Furthermore, the reference voltage generator 140 provides a constant voltage Vyref2 to serve as the second reference voltage Vyref when the battery voltage VBAT reaches the predetermined voltage.

After this, in step S206, the comparator 170 compares a battery voltage VBAT with the second reference voltage Vyref, and produces a voltage comparison signal VCS accordingly.

In step S208, the logic control circuit 180 produces a set of control signals S1 and S2 according to the voltage comparison signal VCS.

In step S210, the power stage circuit 190 produces an adjusted charging voltage VCV′ according to the control signals S1-S2 and a charging voltage VCV. In the embodiment, the charging current ICC is produced by the adjusted charging voltage VCV′ to charge the battery 200, and the battery voltage VBAT is the voltage level of the battery 200. For instance, the power stage circuit 190 switches between the charging voltage VCV and a ground GND according to the control signals S1 and S2 to produce the adjusted charging voltage VCV′. It should be noted that the power stage circuit 190 of the exemplary embodiments produce a pulse width modulation signal by switching the transistors 192 and 194. In other words, the adjusted charging voltage VCV′ is a pulse width modulation signal. Moreover, the charging current ICC is produced by the adjusted charging voltage VCV′ to charge the battery 200. The process ends at step S210.

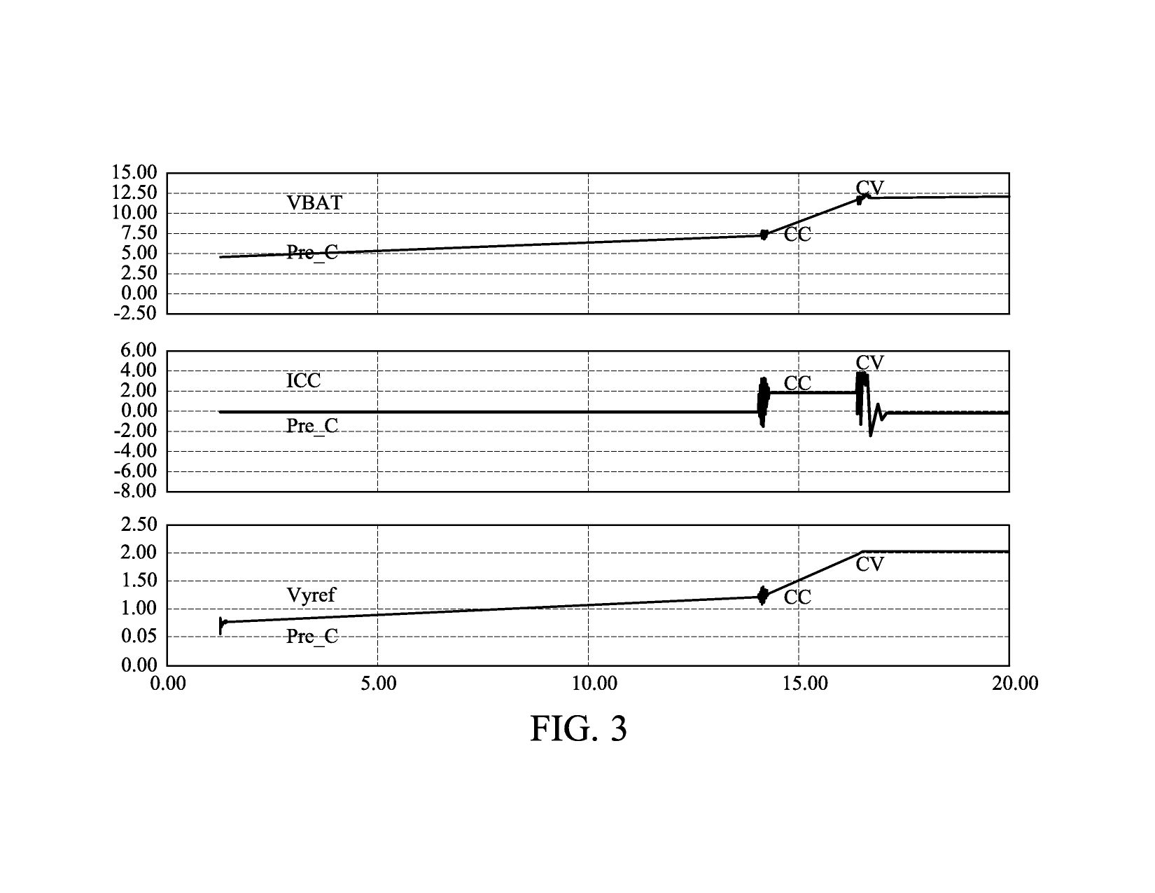

FIG. 3 is a signal simulation diagram illustrating signals of the charging device of the exemplary embodiments. FIG. 3 includes the simulations of the battery voltage VBAT, the charging current ICC, and the second reference voltage Vyref during the pre-charge mode Pre_C, the constant voltage mode CV, and the constant current mode CC respectively. As shown in FIG. 3, during the pre-charge mode Pre_C, the charging device 100 provides a lower charging current ICC (such as 0.2 A) to charge the battery 200. During the pre-charge mode Pre_C, the battery voltage VBAT and the second reference voltage of the Vyref battery 200 slowly raise up due to the lower current provided by the charging device 100. During the constant current mode CC, the charging device 100 provides a higher charging current ICC (such as 2 A) to charge the battery 200, wherein the charging current ICC is a direct current (DC). During the constant current mode CC, the battery voltage VBAT and the second reference voltage Vyref raise up due to the higher charging current ICC provided by the charging device 100. During the constant voltage mode CV, the charging device 100 provides a constant voltage corresponding to 12V to the comparator 170, such that the voltage of the battery 200 is raised to the constant voltage (such as 12V).

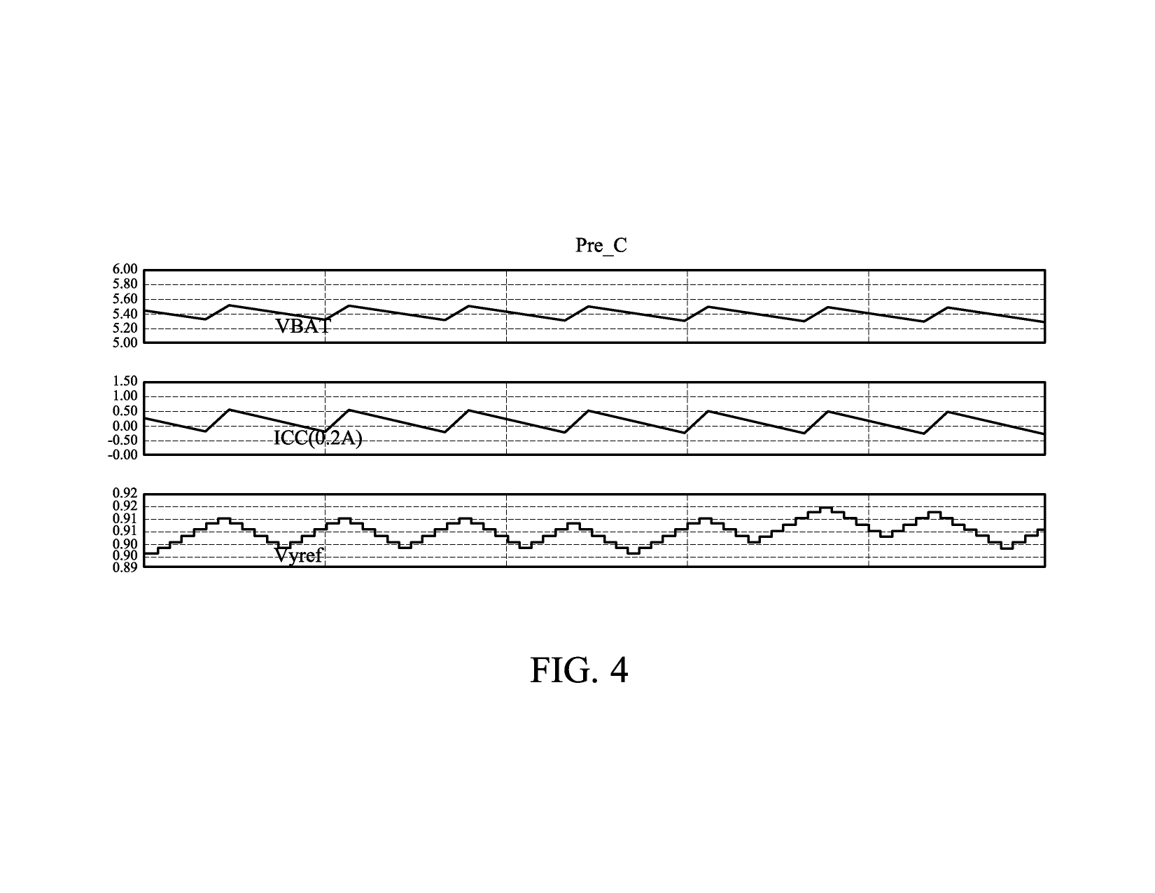

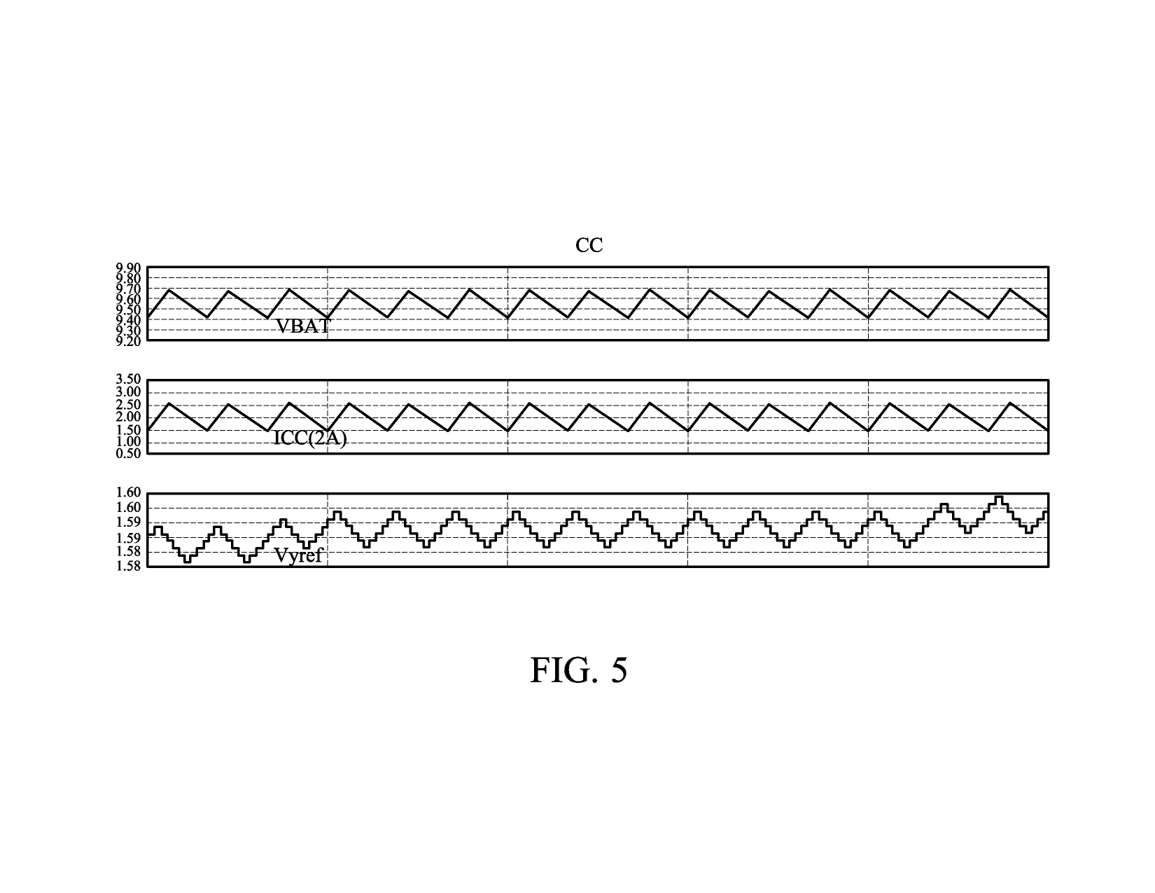

FIG. 4 and FIG. 5 are signal simulation diagrams illustrating signals of the charging device of the exemplary embodiments. FIG. 4 includes the simulations of the battery voltage VBAT, the charging current ICC, and the second reference voltage Vyref during the pre-charge mode Pre_C. FIG. 5 includes the simulations of the battery voltage VBAT, the charging current ICC, and the second reference voltage Vyref during the constant current mode CC. As shown in FIG. 4 and FIG. 5, during the pre-charge mode Pre_C and the constant current mode CC, the battery voltage VBAT increases and mobilizes slightly with the charging current ICC which is rising. The charging current ICC fixes at 0.2 A and 2 A during the pre-charge mode Pre_C and the constant current mode CC respectively. It should be noted that the charging current ICC is a direct current formed by triangle waves. The second reference voltage Vyref steps up or down according to the charging current ICC.

The exemplary embodiments provide a battery charging device and a battery charging method to charge the battery by a single loop. The battery charging device and method have the functions of traditional constant current charging and constant voltage charging. Furthermore, the battery charging device and method also simplify the circuit used for providing the additional constant current, provide a stable and secure charging device/method, and increase battery performance as well as extend battery service life. It should be noted that the charging device 100 of the exemplary embodiments have a reference current generator 120 with changeable constant current sources I1-IN, such that the charging current ICC for charging the battery 200 can be changed under different environments. Therefore, the charging device 100 of the exemplary embodiments is especially suitable for solar batteries which have an unstable charging voltage VCV.

Data transmission methods, or certain aspects or portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application-specific logic circuits.

While the exemplary embodiments have been described by way of example and in terms of the disclosed embodiments, it is to be understood that the exemplary embodiments are not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A charging device, applied to charge a battery, comprising:
a current detecting circuit, detecting a charging current and producing a current-detecting signal according to the charging current;
a first comparator, comparing the current-detecting signal with a first reference voltage, and producing a current comparison signal accordingly;
a reference voltage generator, producing a second reference voltage according to the current comparison signal;
a second comparator, comparing a battery voltage of the battery with the second reference voltage, and producing a voltage comparison signal accordingly;
a logic control circuit, producing a set of control signals according to the voltage comparison signal; and
a power stage circuit, receiving a charging voltage, and controlling the charging voltage according to the set of control signals to produce an adjusted charging voltage, wherein the charging current is produced by the adjusted charging voltage to charge the battery.

2. The charging device as claimed in claim 1, wherein the power stage circuit further comprises:
a first transistor, having a first terminal coupled to the charging voltage, a second terminal coupled to the current detecting circuit, and a control terminal coupled to the logic control circuit; and
a second transistor, having a first terminal coupled to the current detecting circuit, a second terminal coupled to a ground, and a control terminal coupled to the logic control circuit, wherein the first and second transistors switch according to the set of control signals to produce the adjusted charging voltage.

3. The charging device as claimed in claim 1, wherein the reference voltage generator further comprises:
a dynamic voltage generator, producing a dynamic voltage according to the current comparison signal;
a constant voltage generator, producing a constant voltage; and
a switch, providing the dynamic voltage to the second comparator to serve as the second reference voltage when the battery voltage is less than a predetermined voltage, and proving the constant voltage to the second comparator to serve as the second reference voltage when the battery voltage reaches the predetermined voltage.

4. The charging device as claimed in claim 1, wherein the current detecting circuit further comprises:
a resistor, having a first terminal coupled to the power stage circuit and a second terminal coupled to a node; and
a signal generator, producing the current-detecting signal corresponding to the charging current according to a voltage drop produced by the resistor and the charging current, wherein the node is connected to the battery.

5. The charging device as claimed in claim 1, further comprising a reference current generator, producing the first reference voltage corresponding to a predetermined charging current.

6. The charging device as claimed in claim 5, wherein the reference current generator further comprises:
a plurality of constant current sources;
a plurality of switches, wherein each of the switches has a first terminal coupled to the plurality of constant current sources and a second terminal; and
a resistor, having a first terminal coupled the second terminals of the switches, and a second terminal coupled to a ground, wherein the plurality of switches connect at least one of the plurality of constant current sources with the resistor according to a predetermined value, and the resistor produces the first reference voltage according to a current provided by at least one of the plurality of constant current sources.

7. The charging device as claimed in claim 1, further comprising a filter circuit filtering the adjusted charging voltage and the charging current.

8. The charging device as claimed in claim 7, wherein the filter circuit comprises:
an inductor, having a first terminal coupled to the current detecting circuit and a second terminal coupled to a node;
a capacitor, having a first terminal coupled to the node, and a second terminal; and
a resistor, having a first terminal coupled to the second terminal of the capacitor, and a second terminal coupled to a ground, wherein the node is connected to the battery.

9. The charging device as claimed in claim 1, further comprising a voltage divider circuit dividing the battery voltage, and providing a divided voltage to the second comparator.

10. The charging device as claimed in claim 9, wherein the voltage divider circuit comprises:
a first resistor, having a first terminal coupled to a node and a second terminal; and
a second resistor, having a first terminal coupled to the second terminal of the first resistor, and a second terminal coupled to a ground, wherein the node is connected to the battery.

11. A charging method, comprising:
detecting a charging current and producing a current-detecting signal according to the charging current;
comparing the current-detecting signal with a first reference voltage and producing a current comparison signal accordingly;
producing a second reference voltage according to the current comparison signal;
comparing a battery voltage of a battery with the second reference voltage and producing a voltage comparison signal accordingly;
producing a set of control signals according to the voltage comparison signal; and
producing an adjusted charging voltage according to the set of control signals and a charging voltage, wherein the charging current is produced by the adjusted charging voltage to charge the battery.

12. The charging method as claimed in claim 11, wherein the step of producing the adjusted charging voltage further comprises switching a plurality of transistors according to the set of control signals to produce the adjusted charging voltage.

13. The charging method as claimed in claim 11, wherein the step of producing the second reference voltage comprises:
producing a dynamic voltage to serve as the second reference voltage according to the current comparison signal when the battery voltage is less a predetermined voltage; and
providing a constant voltage to serve as the second reference voltage when the battery voltage reaches the predetermined voltage.

14. The charging method as claimed in claim 11, wherein the step of producing the current-detecting signal comprises producing the current-detecting signal corresponding to the charging current by a voltage drop produced by the charging current which is passing through a resistor.

15. The charging method as claimed in claim 11, wherein the step of producing the first reference voltage comprises:
conducting at least one of a plurality of constant current sources with a resistor according to a predetermined value; and
producing the first reference voltage according to the conducted plurality of constant current sources.
